(19) United States
(12) Patent Application Publication
(10) Pub. No.: US 2009/0297656 A1
(43) Pub. Date: Dec. 3, 2009

(54) Liquid Formulation Based On a Guanidinoacetic Acid Component

(76) Inventors: Thomas Gastner, Engelsberg (DE); Hans-Peter Krimmer, Kirchweldach (DE); Sturm Werner, Tacherting (DE)

Correspondence Address: FULBRIGHT & JAWORSKI, LLP, 666 FIFTH AVE, NEW YORK, NY, 10103-3198, US

(21) Appl. No.: 11/989,378

(22) PCT Filed: Aug. 1, 2006
(86) PCT No.: PCT/EP2006/007609

§ 371 Date: Jul. 14, 2009

(30) Foreign Application Priority Data
Aug. 2, 2005 (DE) 10 2005 036 244.3

(51) Int. Cl. A23K 1/18; A23L 2/38

(52) U.S. Cl. 426/2; 426/590

(57) ABSTRACT

The present invention relates to a liquid formulation for human and animal nutrition, consisting of an aqueous solution, a guanidinoacetic acid component and at least one methyl group donor from the group of choline, methionine and betaine. In addition to the free guanidinoacetic acid, it is also possible to use salts, adducts and/or complexes as the guanidinoacetic acid component, which can additionally be combined with further physiologically active compounds. Since the guanidinoacetic acid component is present in dissolved form, formulations including those in the form of mineral water, lemonade, alcoholic drinks and drinking water formulations are envisaged. It has been found that, surprisingly, the guanidinoacetic acid component present in this liquid formulation has very good stability and is converted very rapidly to creatine in the body.

The present invention relates to a novel preparation for human nutrition which contains, as nutritionally active ingredient, a guanidinoacetic acid component and a methyl group donor from the series choline, methionine or betaine.

Guanidinoacetic acid was isolated for the first time by C. J. Weber in 1934 from the urine of dogs and humans. Weber already suspected that it is the metabolic precursor of creatine (Weber, C. J., Proc. Sot. Exp. Biol. and Med., 33, 172 (1934)).

A little later it was found that guanidinoacetic acid is actually an endogenous substance occurring in animals and also humans and which takes a central role in the biosynthesis of creatine. Creatine can be both taken in via the diet and also formed endogenously. Creatine biosynthesis proceeds from glycine and L-arginine. In mammals, especially in the kidneys, but also in liver and pancreas, the guanidino group of L-arginine is cleaved by the enzyme aminotransferase and an N—C—N group is transferred to glycine. The L-arginine in this case is converted to L-ornithine. The guanidinoacetic acid thus formed is converted to creatine in the next step by means of the enzyme transmethylase, in vertebrates this proceeds exclusively in the liver. In this case, S-adenosyl-methionine acts as methyl group donor. The creatine subsequently diffuses into the blood circulation and is thus transported to the target organs. Transport through the cell membrane into the cells proceeds in this case via a specific creatine transporter.

Creatine plays an important role in the energy metabolism of the cell, wherein, as a high-energy phosphocreatine, in addition to adenosine triphosphate (ATP) it is an important energy reserve of muscle. In the muscle resting state, ATP can transfer a phosphate group to creatine, wherein phosphocreatine is formed which is then in direct equilibrium with ATP. During muscle work, it is of critical importance to replenish the ATP stores as rapidly as possible. Phosphocreatine is available for this in the first seconds of maximum muscle load. In this case, in a very rapid reaction a phosphate group can be transferred to adenosine diphosphate by the enzyme creatine kinase and thus ATP is reformed. This is also called the Lohmann reaction.

Creatine has long been known as a suitable food supplement and feed. During heavy muscle work continuing over a relatively long time, the creatine stores naturally present in the body are rapidly exhausted. For this reason, in particular in the case of competitive athletes, targeted creatine administration has acted beneficially on stamina and efficiency, wherein unwanted enrichment processes in the body or disadvantageous breakdown products are unknown. The reason for this is that creatine, in the event of excess supply, is excreted from the body via the kidneys. In addition, creatine is converted at a constant rate into the cyclic waste product creatinine, which is likewise excreted via the kidneys. This is therefore a second metabolic breakdown pathway.

In addition, it is known that creatine supplementation leads to an increase in body mass. This is due to the start of an increased uptake of water into the muscle. In the long term, the creatine, however, leads indirectly via increased protein synthesis or/and reduced protein catabolism in the myofibrils to an increase in muscle mass (Int J Sports Med 21 (2000), 139-145). An increased nonfat body mass is obtained as a result.

In addition to creatine itself, that is to say in particular creatine monohydrate, in the interim, numerous creatine salts such as, for example, creatine ascorbate, citrate, pyruvate and other salts have likewise proved suitable food supplements. As prior art, at this point mention may be made of European patent EP 894 083 and German laid-open application DE 197 07 694 A1 as representatives.

The effects demonstrated as beneficial for humans are also developed by creatine in animals, for which reason its use in diverse feeds has likewise been copiously described. For instance, in the international patent application WO 00/67 590, the use of creatine or creatine salts as feed additive for breed stock and fat stock, as a substitute for bonemeal, fishmeal and/or antimicrobial growth promoters, growth hormones and also anabolics is described. GB 2 300 103 teaches the use of creatine in the form of a dog biscuit, for which the creatine monohydrate together with meat is offered in an extruded mix. Since creatine monohydrate, on account of its poor solubility, is only insufficiently bioavailable, its co-use with other physiologically active compounds, preferably in salt form, is recommended. German laid-open application DE 198 36 450 A1 relates to the use of stable salts of pyruvic acid, and in particular creatine pyruvate, in formulations which are suitable for animal nutrition.

DE 100 03 835 A1 relates to formulations for dehydrated states, as occur generally for older persons and, in particular, those having limited mobility. In this case creatine acts as transport medium for water in order to supply moisture to tissue most severely affected by dehydration symptoms.

In addition to its uncontested beneficial physiological properties, creatine, however, also has the disadvantage that, as creatine monohydrate, it does not have expressed stability in aqueous solutions, with it being converted into creatinine. The rate of breakdown is dependent on the pH of the solution and temperature, with the concentration not playing a role. Particularly in the acid pH region, this breakdown to creatinine proceeds very rapidly. At room temperature and pH 3.5, creatine is already more than 20% converted to creatinine after 3 days and the physiological effect is lost. A pH of 3.5 is a typical pH for, for example, a soft drink. Owing to the rapid breakdown of creatine in this environment, the use of creatine, in particular creatine monohydrate, in aqueous or moist formulations for human and animal nutrition is virtually excluded. Even the pH in the stomach of 1 to 2 can, depending on the residence time, lead to significant breakdown of creatine to form creatinine. For instance, in humans, it was found that after oral administration of creatine, only about 15 to 30% of the creatine can be resorbed by the musculature (Greenhaff, P. L. Factors Modifying Creatine Accumulation In Human Skeletal Muscle. In: Creatine. From Basic Science to Clinical Application. Medical Science Symposia Series Volume 14, 2000, 75-82).

A plurality of working groups showed as early as in the 1950s in clinical studies that administration of guanidinoacetic acid in combination with betaine in heart disorders had a beneficial effect on the course of the disease. The patients reported a significant improvement of their general state of health. In addition, improved stamina during physical exertion and increased muscle power were established even after a short treatment duration. The patients also reported an improved libido. 200 patients were administered a dose of 30 mg/kg daily for one year. No side effects were observed (Borsook H.; Borsook M. E.: The biochemical basis of betaine-glycocyamine therapy. In: Annals of western medicine and surgery 5(10), 825, 1951).

It is further known that supplemented guanidinoacetic acid is converted to creatine in the body. For instance WO 91/07954 describes the use of guanidinoacetic acid in physiological states which require an increase in the creatine level.

In the context of methionine overdosing, it is likewise known that adverse effects associated therewith can be ameliorated by the administration of guanidinoacetic acid (Interrelations of choline and methionine in growth and the action of betaine in replacing them. McKittrick, D. S. Univ. of California, Berkeley, Archives of Biochemistry (1947), 15 133-55).

The international patent application WO 2004/000297 describes a mixture for nutrition or for pharmaceutical purposes which is used for mammals. This consists of a protein fraction which contains L-serine and, as further component, guanidinoacetic acid. The mixture is said in this case to be free from glycine or, after hydrolysis of the mixture, to contain a ratio of L-serine to glycine of greater than 2.7 to 1. As a possible product form, solutions, emulsions, suspensions, gels, bars, sweets and preferably powders are stipulated.

It is further known of guanidinoacetic acid that it has an antibacterial activity and has been successfully used against bacterial infections (Staphyllococcus aureus) in animal experiments (Preparation for protecting mammals against infection (Stanley Drug Products Inc., USA). Neth. Appl. (1976), 7 pp. NL 7411216).

Recently, guanidinoacetic acid has also been used as food supplement and feed. For instance, it has been found only recently that guanidinoacetic acid, compared with creatine, has a significantly better bioavailability. In a feeding experiment with chickens, even with the addition of less than 0.1% guanidinoacetic acid in the feed, a weight gain of 7% and a lower feed consumption of 6% compared with the control group was observed. In contrast thereto, the addition of 0.2% creatine to the feed led only to a weight gain of 4% and a lower feed consumption of 2 to 3%.

In addition, it has been found that guanidinoacetic acid develops its maximum activity even at a dosage at which creatine leads to no observable effect. The improved weight gain and the improved food utilization at very low dosage may be explained by a high rate of conversion of the guanidinoacetic acids consumed in creatine. For instance, even an addition of 0.032% guanidinoacetic acid to hens' feed led to a weight gain of 3% and an improved feed utilization of 3% (WO 2005/120246 A1). This also coincides with the observation that the enzyme transmethylase is found in very high concentrations in the liver.

Because of the relatively poor solubility of guanidinoacetic acid in water, attempts have already been made to improve the solubility and to further increase bioavailability, wherein, simultaneously, the known good physiological properties of guanidinoacetic acid should be retained. For this purpose, novel stable salts and/or addition compounds and/or complex compounds of guanidinoacetic acid with malic acid, aspartic acid, ascorbic acid, succinic acid, pyruvic acid, fumaric acid, gluconic acid, α-ketoglutaric acid, oxalic acid, pyroglutamic acid, 3-nicotinic acid, lactic acid, citric acid, maleic acid, sulfuric acid, acetic acid, formic acid, 2-hydroxybenzoic acid, L-carnitine, acetyl-L-carnitine, taurine, betaine, choline, methionine and lipoic acid and also as sodium, potassium or calcium guanidinoacetate have been provided (DE 10 2005 009 990.4; still unpublished).

Using these novel compounds, compared with the free guanidinoacetic acid, higher water solubility can be achieved and also with respect to their stability and bioavailability, these compounds are of at least equal value to free guanidinoacetic acid.

From the disadvantages of the prior art described with respect to creatine, the object of the present invention was to find aqueous formulations for human nutrition which, if possible, have a low instability in industrial processing processes. In addition, they should withstand undamaged high processing temperatures as occur in sterilization, and also be storage stable over months in industrially produced ready-to-drink products. In addition, the compound, in contrast to creatine, should withstand the acid environment of the stomach undamaged and not be converted into creatine until after uptake into the body. The formulation used should not itself develop any physiologically adverse effects and be easy to detect. From economic aspects, for the substances to be used according to the invention, producing them in an economically favorable manner is also of major importance.

This object is achieved by providing a liquid formulation consisting of an aqueous solution of at least one guanidinoacetic acid component and a methyl group donor from the series choline, methionine and betaine.

Surprisingly, it has been found that, by means of this formulation, not only was the object met in full, in that the guanidinoacetic acid components present therein are stable even over a relatively long time in these water-containing preparations, and are converted very rapidly into creatine in the body. In the production process, aqueous preparations, such as those according to the invention, also, are generally pasteurized or sterilized. In this case, it has surprisingly been found that guanidinoacetic acid, in contrast to creatine, also has under these, in part extreme, conditions, an outstanding stability. These advantages were unexpected in this manner in their totality.

As preferred guanidinoacetic acid components, the present invention provides guanidinoacetic acid and/or at least one salt, an addition compound or complex compound thereof.

Particularly preferably, according to the invention, the guanidinoacetic acid component should be compounds between guanidinoacetic acid and malic acid, aspartic acid, ascorbic acid, succinic acid, pyruvic acid, fumaric acid, gluconic acid, α-ketoglutaric acid, oxalic acid, pyroglutamic acid, 3-nicotinic acid, lactic acid, citric acid, maleic acid, sulfuric acid, acetic acid, formic acid, 2-hydroxybenzoic acid, L-carnitine, acetyl-L-carnitine, taurine, betaine, choline, methionine and lipoic acid and also sodium, potassium or calcium.

The quantitative ratio of guanidinoacetic acid component to the methyl group donor can be varied within wide limits. However, it has proved to be particularly advantageous to use the guanidinoacetic acid component and the methyl group donor in a weight ratio of 1:10 to 10:1.

Particularly preferably, the liquid formulation of the invention has a water content ≧10% by weight, in particular ≧20% by weight, based on the total weight.

Obviously, the proposed formulation is not limited to the guanidinoacetic acid component as sole active ingredient. For this reason, the present invention also provides a variant in which the formulation can contain further physiologically active compounds which are selected from the series carbohydrates, fats, amino acids, proteins, vitamins, minerals, trace elements and also derivatives thereof and mixtures thereof.

In comparison with creatine, guanidinoacetic acid has a lower solubility in water (3.8 g per liter at room temperature). However, for the claimed preparation, this is not disadvantageous, since guanidinoacetic acid already develops its activity in a significantly lower dose range than creatine monohydrate. Whereas for creatine monohydrate, daily doses of 5 to 20 g are conventional, already on administration of a daily dose of 2 g of guanidinoacetic acid, markedly beneficial effects are observed (Borsook H.; Borsook M. E.: The biochemical basis of betaine-glycocyamine therapy. In: Annals of western medicine and surgery 5(10), 825, 1951). Therefore, for example, even in half a liter of an aqueous drink, a physiologically meaningful daily dose of the guanidinoacetic acid component can be incorporated without problem. On account of the recently increasing supply of suitable guanidinoacetic acid salts, however, solutions having significantly higher concentrations of the guanidinoacetic acid component are also possible.

Owing to the unexpected beneficial properties, the present invention takes into account, as a further variant, the possibility that the preparation is present as mineral water, lemonade, sports drink, mineral drink, fruit drink, fruit juice drink, milk drink, whey drink or alcoholic drink, or as drinking water preparation.

The formulation is not limited with respect to the guanidinoacetic acid component, wherein, in particular, the amounts of the guanidinoacetic acid component in which it can be present in the preparation is not a limitation. For economic and nutritional reasons, however, amounts are recommended which are between 0.01 and 4% by weight. Particular preference is given to amounts between 2.5 and 4.0% by weight, and in particular 3.8% by weight.

The present invention also takes into account the use of the claimed preparation as physiological tonic and in this context, in particular, in the form of a functional food for humans, with the school, sport, convalescence and/or geriatric sectors being in the foreground.

Obviously, it is also possible to use the proposed preparation together with food supplements, which the present invention likewise provides. Here, in particular, the medical sector is of interest.

Overall, the proposed formulation, the aqueous solution of which has a preferred pH range between 2.5 and 11, and its use are a further advance of the prior art with respect to the free guanidinoacetic acid and its salts and addition compounds in combination with a methyl group donor from the series choline, methionine and betaine. This is because it is now possible to use these compounds, not only in dry preparations, but also as storage-stable solutions, wherein the proposed formulations are also outstandingly suitable for the industrial preparation of drinks. Guanidinoacetic acid and its salts, and also addition compound or complex compound, are also stable over a plurality of months in the novel formulations and they can, furthermore, be supplied to the body in excellent bioavailability, wherein the guanidinoacetic acid component administered in each case is converted in the body very rapidly into creatine.

The examples hereinafter illustrate the advantages of the present invention.

### EXAMPLES

### 1. Food Supplement

Hereinafter, typical compositions of good-tasting formulations are listed, the ingredients of which are introduced at room temperature into 500 ml of fruit juice and/or water and/or yoghurt and/or whey.

| | | | |
|---|---|---|---|
| 1.1 | 1500 | mg | glucosamine |
| | 1 800 | mg | guanidinoacetic acid |
| | 3 600 | mg | betaine |
| | 720 | mg | magnesium L-hydrogenaspartate |
| | 2 000 | mg | glucose |
| | 500 | mg | ascorbic acid |
| 1.2 | 400 | mg | chondroitin sulfate |
| | 4 000 | mg | guanidinoacetic acid citrate |
| | 8 000 | mg | betaine |
| | 2 000 | mg | dicalcium phosphate |
| | 400 | mg | (MgCO₃)₄—Mg(OH)₂•5H₂O = approximately 100 Mg |
| | 500 | mg | vitamin C |
| 1.3 | 1 000 | mg | glucosamine |
| | 300 | mg | chondroitin sulfate |
| | 2 800 | mg | guanidinoacetic acid pyruvate |
| | 6 000 | mg | betaine |
| | 500 | mg | methionine |
| | 3 100 | mg | creatinol phosphate |

### 2. Storage Stability:

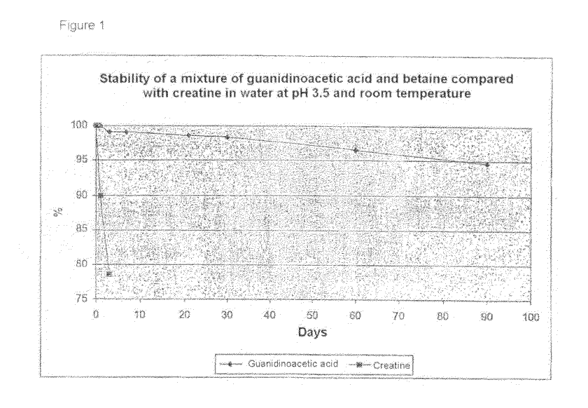

According to FIG. 1, the storage stability of creatine was determined in comparison with a mixture of 4 parts by weight of guanidinoacetic acid and 6 parts by weight of betaine in aqueous solution at pH 3.5 and room temperature: whereas creatine, after 3 days, is already more than 20% converted to creatinine, in the mixture of guanidinoacetic acid and betaine under identical conditions, after 90 days, 95% of the initial amount was still detectable as guanidinoacetic acid. Betaine under the stated conditions is completely stable.

1-10. (canceled)

11. A method for making a ready to drink product comprising admixing in an aqueous solution a guanidinoacetic acid compound and at least one methyl group donor selected from the group consisting of choline, methionine, and betaine.

12. The method of claim 11, wherein said guanidinoacetic acid compound is guanidinoacetic acid, a guanidinoacetic acid salt, a guanidinoacetic acid addition compound, or a guanidinoacetic acid complex compound.

13. The method of claim 11, wherein said guanidinoacetic acid corn pound is present at a concentration of from 0.1 g/l to 4.0 g/l.

14. The method of claim 13, wherein said guanidinoacetic acid compound is present at a concentration of from 2.5 g/l to 3.5 g/l.

15. The method of claim 11, wherein said guanidinoacetic acid compounds is (i) guanidinoacetic acid, malic acid, ascorbic acid, succinic acid, pyruvic acid, fumaric acid, gluconic acid, α-ketoglutaric acid, oxalic acid, pyroglutamic acid, 3-nicotinic acid, lactic acid, citric acid, maleic acid, sulfuric acid, acetic acid, formic acid, 2-hydroxybenzoic acid, L-carnitine, acetyl-L-carnitine, taurine, betaine, choline, methionine, lipoic acid, or (ii) a sodium, potassium or calcium salt of (i).

16. The method of claim 11, wherein said guanidinoacetic acid compound and methyl group donor are present in a weight ratio of from 1:10 to 10:1.

17. The method of claim 11, wherein said ready to drink product further comprises at least one carbohydrate, fat, amino acid, protein, vitamin, mineral, trace element, or a derivative thereof.

18. The method of claim 11, wherein said ready to drink product is mineral water, lemonade, a sport drink a mineral drink, a fruit drink, a milk drink, a whey drink, an alcoholic beverage, or drinking water.

19. The method of claim 11, wherein said ready to drink product has a pH from 2.5 to 11.

20. A method for administering nutrient to a subject in need thereof comprising administering to said subject a ready to drink product prepared by the method of claim 1, and a food supplement.

21. A liquid ready to drink product consisting of an aqueous solution of a guanidinoacetic acid compound and at least one methyl group donor selected from the group consisting of choline, methionine, and betaine.
